(19) United States
(12) Patent Application Publication
(10) Pub. No.: US 2025/0102446 A1
(43) Pub. Date: Mar. 27, 2025

(54) OPTICAL SYSTEMS AND METHODS OF PROVIDING A COUPLING MIRROR TO AN OPTICAL SYSTEM

(71) Applicant: Applied Materials Israel Ltd., Rehovot (IL)

(72) Inventor: Menachem LAPID, Hashmonaim (IL)

(21) Appl. No.: 18/896,800

(22) Filed: Sep. 25, 2024

(30) Foreign Application Priority Data
Sep. 26, 2023 (IL) 307265

(51) Int. Cl. G01N 21/88; G01N 21/95

(52) U.S. Cl. CPC G01N 21/8806; G01N 21/8851; G01N 21/9501; G01N 2021/8809; G01N 2021/8825; G01N 2201/0636

(57) ABSTRACT

The present disclosure relates to a method of providing a light signal separation unit in an optical reflective microscope system, said optical reflective microscope system comprising an objective lens arrangement configured to collect light reflected off a plurality of field points on an object and to onwardly transmit a light beam formed from the collected light and said light signal separation unit having a reflective surface with a central transmissive region formed therein, wherein said central transmissive region is arranged to allow therethrough a central portion of said light beam transmitted from said objective lens arrangement while said reflective surface is arranged to reflect a peripheral portion of said light beam transmitted from said objective lens arrangement. The method comprises determining an axial position at which to position said light signal separation unit. The axial position being a position along an optical axis of said objective lens arrangement, contiguous to an exit pupil of said objective lens arrangement, at which beam deformation of said light beam is substantially minimal; determining a dimension of a cross section of said light beam at said axial position; and determining a dimension of said central transmissive region based on said dimension of said cross section of said light beam and said lateral displacement at said axial position.

### RELATED APPLICATIONS

This application claims the benefit of priority from Israeli Patent Application No. 307265, filed Sep. 26, 2023, which is incorporated herein by reference.

### TECHNOLOGICAL FIELD

The present technology relates to optical microscope systems and methods of providing a light signal divider or light signal separation unit (coupling mirror) in reflective optical microscope systems. The present technology may be implemented in an optical inspection system comprising a reflective optical microscope system disclosed herein for inspecting a specimen or an object, for example, but not limited to, semiconductor wafer and/or mask inspection systems.

### BACKGROUND ART

There exist a variety of systems for use in inspections of specimens. These systems may include optical systems such as various microscopes (conventional and digital) and microscope arrangements, and the specimens may include any organic or inorganic specimens such as, amongst other things, semiconductor wafers and masks.

A conventional optical inspection system generally comprises an objective for collecting or receiving light from a specimen under inspection. The objective may comprise one or more objective lenses and form an image of the specimen at infinity. The objective may form a part of an objective lens arrangement that further comprises additional lenses such as a telescope to further change the image magnification of the specimen. For example, an objective lens may be arranged to receive and focus light onto an intermediate focal plane, and the objective and the one or more additional lenses may further be configured to relay the light from the intermediate focal plane to an exit pupil of the objective lens arrangement. The specimen may be illuminated by a suitable light source, and the specimen reflects and/or scatters the light from the light source. Imaging the light collected from the specimen enables analyses of surface (or internal) structure of the specimen. The specimen may be received and secured on a stationary platform or moved on a stage mechanism that allows the specimen to be moved in one dimension (e.g. varying a distance between the specimen and the objective lens or objective lens arrangement along a z-axis), two dimensions (e.g. along the z-axis and in a scan direction, x-axis or y-axis, orthogonal to the z-axis), or in three dimensions, as desired. The light source may be external to the optical inspection system or provided as an integral part of the optical inspection system as desired, and may include aerial illumination, a single point light source (e.g. a laser) or an array of point light sources, varying in wavelengths and intensities, as desired. The objective lens arrangement onwardly transmits the light (reflected, transmitted and/or scattered) collected from the specimen, then an imaging lens, disposed along the optical axis of and behind the objective lens arrangement, forms a magnified image of the specimen (or a part of the specimen) with the light from the objective lens arrangement on an image plane, or back focal plane, of the imaging lens. The magnified image of the specimen (or part of the specimen) may then be detected using one of a variety of optical detector apparatus, including an optical detectors array e.g. of CCD detectors, photo diodes, or photomultipliers, etc. Herein, a “magnified image” can include both an enlarged image of a (part of a) specimen, a reduced image or an image of the same scale as the specimen; in other words, a magnified image may have a magnification of >1, <1 or equal to 1.

In some implementations, it may be desirable to separate the light collected from a given part of a specimen into different portions. For example, in defect inspection, it may be desirable to separate the central or inner portion of the collected light from the peripheral or outer portion. In some implementations in which the specimen is illuminated from the center (i.e. substantially perpendicular to the specimen surface), the central portion corresponds to light directly reflected off the specimen surface (brightfield) such that dark regions (in a light background) represent defects on the surface, while the peripheral portion corresponds to light scattered by the defects on the specimen surface (darkfield) such that light regions (in a dark background) represent the defects.

In these implementations, a light signal separation unit (coupling mirror) may be employed and disposed behind the objective lens arrangement to separate the peripheral portion of a light beam formed by the light collected by the objective lens arrangement from the central portion of the light beam. Such a light signal separation unit may be implemented in the form of a mirror or otherwise a device having a reflective surface (e.g. a reflective coating) having formed therein an opening or otherwise transmissive region substantially in the center, such that the central portion of light incident on the light signal dividing unit passes through the central opening or transmissive region while the peripheral portion is reflected by the reflective surface. Herein, a transmissive region of a light signal dividing unit or coupling mirror may refer to an opening in the light signal dividing unit or a region of the unit that is uncoated by a reflective coating and therefore allows the transmission of light therethrough.

Conventional approaches to designing such light signal dividing units is to begin with a central opening or transmissive region diameter that is much larger than an “ideal” diameter derived from the optics of the objective lens arrangement, then experimentally determine the transmissive region diameter through trial and error by gradually reducing the diameter until an outer part of the central portion of light is blocked by the edge of the central opening or transmissive region. These methods can be time consuming and may not even achieve optimal diameter.

It is therefore desirable to provide improved methods of providing light signal separation units to optical microscope systems for effective separation and collection of light from a specimen.

### GENERAL DESCRIPTION

An aspect of the present technology provides a method of providing a light signal separation unit in an optical reflective microscope system, the optical reflective microscope system comprising an objective lens arrangement configured to collect light reflected off a plurality of field points on an object and to onwardly transmit a light beam formed from the collected light, and the light signal separation unit having a reflective surface with a central transmissive region formed therein, wherein the central transmissive region is arranged to allow therethrough a central portion of the light beam transmitted from the objective lens arrangement while the reflective surface is arranged to reflect a peripheral portion of the light beam transmitted from the objective lens arrangement, the method comprising: determining an axial position at which to position the light signal separation unit, the axial position being a position along an optical axis of the objective lens arrangement, proximal to an exit pupil of the objective lens arrangement (i.e. proximal to a paraxial exit pupil or paraxial exit pupil plane), at which beam deformation (size-movement for different illuminated field points) of the light beam is substantially minimal; determining a dimension of a cross section of the light beam at the axial position; obtaining a lateral displacement of the light beam with respect to the plurality of field points on the object at the axial position; and determining a dimension of the central transmissive region based on the dimension of said cross section of the light beam adjusted by the lateral displacement at the axial position. Herein, “axial positions” generally refer to positions along the optical axis of the objective lens arrangement, while “lateral positions” generally refer to positions on a plane orthogonal to the optical axis.

According to embodiments of the present technology, a light signal separation unit (coupling mirror) is designed based on a bottom-up approach, in that the dimension of the central transmissive region of the light signal separation unit is determined firstly according to the dimension of the cross section of the light beam exiting the objective lens arrangement at a point where the light beam is less (or least) distorted or deformed, e.g. as a result of aberration and/or alignment variations. It is noteworthy that the dimension of the central transmissive region of the light signal separation unit is also determined according to the dimension of the cross section of the light beam light entering the objective lens arrangement from a previous pupil relay system that images its entrance pupil onto the objective/telescope entrance pupil plane. This point, where the light beam is less (or least) distorted or deformed, is generally proximal to or substantially coincide with the exit pupil (i.e. the paraxial exit pupil) of the objective lens arrangement, and corresponds to a minimum desirable size for the central transmissive region. The magnification errors of said pupil relay system and its self pupil aberration impact shall also be accumulated to set the entrance pupil diameter to avoid that the illumination beam cuts on the coupling mirror. Then one or more adjustments (e.g. from expected errors or variations) to this minimum desirable size are taken into account. For example, the Applicant has recognised that design variations, alignment variations and aberrations may have the effect of displacing laterally a light beam formed from light reflected off different field points on the object, such that the exit pupil may change position as observed along different points in the field of view. This effect is known as pupil wandering (or pupil walking). As such, some lateral displacement in the position of an exit pupil for a light beam formed from reflected light at different specimen's field points may be observed-with respect to the optical axis for light beams originating from different field points. In order for the central transmissive region of the light signal separation unit to be sufficiently wide to allow through substantially all reflected light from different field points on the object, the dimension of the central transmissive region is preferably adjusted for such lateral displacement of the exit pupil position to reduce or otherwise minimise the amount of reflected light from the object being unintentionally reflected by the reflective surface of the light separation unit. Compared to the conventional top-down approach, the present approach is capable of minimising or otherwise significantly reducing unnecessary “spares”, or error margins, in the dimension of the central transmissive region, thus it is possible to improve the amount of light that can be collected from the peripheral portion of the light transmitted from the objective lens arrangement. This is of particular importance in systems with higher numerical apertures (NA), or higher resolving power, in which the objective lens arrangement is capable of receiving light at a wider angle such that the central portion is proportionately much larger than the peripheral portion of received light; in other words, there is proportionately a much smaller peripheral portion to collect.

In some embodiments, the objective lens arrangement may be configured such that the light beam formed from light collected from each field point of the plurality of field points on the object exiting the objective lens arrangement comprises parallel light rays to be imaged at infinity. In other words, the objective lens arrangement in such embodiments may be configured for telecentricity, or to be substantially telecentric, on the specimen (object) side.

The dimension of the cross section of the light beam may be determined using any suitable methods as desired, empirically through measurements, mathematically through application of appropriate equations, or through computer simulations.

In some embodiments, determining a dimension of the cross section of the light beam may comprise measuring a cross-sectional area or a diameter of said light beam at said axial position. In other words, determining the beam deformation may include determining a beam cross section variation at said axial position for a plurality of field points, optionally over whole or substantially the whole the field.

In some embodiments, the objective lens arrangement may comprise a plurality of elements, the method may further comprise reducing the beam deformation and/or reducing the lateral displacement of the light beam by adjusting a relative position of the plurality of elements of the objective lens arrangement.

For an objective lens arrangement that comprises a plurality of elements, such as (but not limited to) an objective lens and a telescope, an alignment of elements of the objective lens arrangement may be calibrated, for example using a calibration object, to optimise or otherwise improve the degree of telecentricity for the objective lens arrangement. Thus, in some embodiments, the method may further comprise illuminating the object through the objective lens arrangement to image an entrance pupil of the objective lens arrangement and an exit pupil formed by the illumination, and adjusting an alignment of one or more elements of the objective lens arrangement such that the entrance pupil substantially overlaps onto the exit pupil of the illumination, wherein, preferably, the objective lens arrangement may be configured such that the entrance pupil and the exit pupil of the illumination are proximal to a back focal plane of the objective lens arrangement.

In some embodiments, the axial position may substantially coincide with the exit pupil of the objective lens arrangement.

In some embodiments, the method may further comprise disposing the light signal separation unit at the axial position. In some embodiments, obtaining a lateral displacement of the light beam with respect to the plurality of field points on the object at the axial position may comprise obtaining a lateral displacement of the light beam for each of the plurality of field points by comparing, for each field point, a position of a light beam formed from light reflected off the field point with respect to the optical axis of the objective lens arrangement.

In some embodiments, determining a dimension of the central transmissive region may comprise adjusting the dimension of the cross section of the light beam by a maximum lateral displacement.

In some embodiments, determining a dimension of the central transmissive region may comprise adjusting the dimension of the cross section of the light beam by a mean lateral displacement.

In some embodiments, the lateral displacement may be represented as a ratio or percentage with respect to the position of the optical axis. Absolute values may also be used if desired.

In some embodiments, the object may be illuminated by an illumination source through the objective lens arrangement, and determining an axial position at which to position the light signal separation unit may comprise determining an axial position at which beam deformation of the light beam is substantially minimal for a plurality of axial and/or lateral exit pupil position of the illumination by varying a relative position of the illumination source and the objective lens arrangement.

In some embodiments, determining a dimension of the cross section of the light beam may comprise generating a computer simulation of the objective lens arrangement, using as inputs physical parameters of the objective lens arrangement and one or more tolerances with respect to the objective lens arrangement, and analysing a resulting simulation.

It may be desirable to reflect the peripheral portion of the light transmitted from the objective lens arrangement off the optical axis of the objective lens arrangement for detection. In some embodiments, the light signal separation unit may be disposed such that a plane of the light signal separation unit is at an angle with respect to an exit pupil plane on which the exit pupil of the objective lens arrangement lies, and the method may further comprise adjusting the dimension of the central transmissive region based on the angle.

In some embodiments, adjusting the dimension of the central transmissive region based on the angle may comprise simulating the dimension of the central transmissive region as a column and determining a cross-sectional area of the column at the angle.

Another aspect of the present technology provides a non-transitory computer-readable medium comprising machine-readable code which, when executed by a processor, causes the processor to perform the method as described above.

A further aspect of the present technology provides a light signal separation unit in an optical reflective microscope system, the optical reflective microscope system comprising an objective lens arrangement configured to collect light reflected off a plurality of field points on an object to onwardly transmit a light beam formed from the collected light, the light signal separation unit comprising: a reflective surface having a central transmissive region formed therein, wherein the central transmissive region is arranged to allow therethrough a central portion of the light beam transmitted from the objective lens arrangement while the reflective surface is arranged to reflect a peripheral portion of the light beam transmitted from the objective lens arrangement, wherein a dimension of the central transmissive region of the light signal separation unit is determined by: determining an axial position at which to position the light signal separation unit, the axial position being a position along an optical axis of the objective lens arrangement, proximal to an exit pupil of the objective lens arrangement, at which beam deformation of the light beam is substantially minimal; determining a dimension of a cross section of the light beam at the axial position; obtaining a lateral displacement of the light beam with respect to the plurality of field points on the object at the axial position; and determining a dimension of the central transmissive region based on the dimension of the cross section of the light beam adjusted by the lateral displacement at the axial position.

A yet further aspect of the present technology provides an inspection system for inspecting an object, comprising: an optical reflective microscope system comprising: an objective lens arrangement configured to collect light reflected off a plurality of field points on an object to onwardly transmit a light beam formed from the collected light; a light signal separation unit as described above; at least one imaging lens arrangement configured to receive light from the light signal separation unit and form an image; and at least one light detector apparatus configured to detect the image formed by the at least one imaging lens arrangement.

In some embodiments, the inspection system may further comprise an illumination source arranged to illuminate said object through said objective lens arrangement by forming an afocal beam at an illumination exit pupil.

In some embodiments, the at least one imaging lens arrangement may comprise a first imaging lens arrangement configured to receive the peripheral portion of the light beam transmitted from the objective lens arrangement reflected by the reflective surface of the light signal separation unit to form a first image, and a second imaging lens arrangement arranged to receive the central portion of the light beam transmitted from the objective lens arrangement through the central transmissive region of the light signal separation unit to form a second image.

In some embodiments, the at least one light detector apparatus comprises a first light detector apparatus configured to detect the first image from the first imaging lens arrangement and a second light detector apparatus configured to detect the second image from the second imaging lens arrangement.

In some embodiments, the inspection system may be a semiconductor wafer and/or mask inspection system.

A further aspect of the present technology provides a wafer inspection tool including an optical reflective microscope system configured to provide a brightfield channel and a darkfield channel. The optical reflective microscope system comprise an objective lens arrangement configured to collect light reflected off a plurality of field points on an object and to onwardly transmit a light beam formed from the collected light and a light signal separation unit comprising a central region and a peripheral region configured for separating the brightfield channel and the darkfield channel. A dimension of said central region of said light signal separation unit is determined by: determining an axial position at which to position said light signal separation unit, said axial position being a position along an optical axis of said objective lens arrangement, proximal to an exit pupil of said objective lens arrangement, at which beam deformation of said light beam is substantially minimal; determining a dimension of a cross section of said light beam at said axial position; and determining a dimension of said central region based on said dimension of said cross section of said light beam at said axial position.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows schematically an exemplary inspection system for inspecting a specimen;

FIG. 2 shows an exemplary comparison between brightfield and darkfield signals in a low resolution/low NA system;

FIG. 3 shows an exemplary comparison between brightfield and darkfield signals in a high resolution/high NA system;

FIG. 4 illustrates an effect of beam deformation along the optical axis;

FIGS. 5A-5B illustrate an exemplary determination of an axial position for positioning a light signal separation unit;

FIG. 6 shows an exemplary light signal separation unit being disposed at an angle;

FIG. 7 shows a flow diagram of an exemplary method of providing a light signal separation unit; and

### DETAILED DESCRIPTION OF EMBODIMENTS

Embodiments of the present technology provides methods for providing a coupling mirror (light signal divider) in reflective optical systems, for example optical systems implemented in microscopes, defect detection apparatuses, specimen inspection apparatuses, etc., to separate a central portion of light collected from an object from a peripheral portion of the light. In the present approach, a light signal separation unit is designed such that the dimension of the central opening or transmissive region is determined starting from the dimension of a cross section of a light beam formed from light collected by an objective lens arrangement of the optical system at an axial position contiguous to the exit pupil of the objective lens arrangement (a theoretical exit pupil plane position thereof), at which beam deformation is substantially minimal then determining and adjusting for one or more tolerances (or expected errors). For example, determining the minimal beam deformation may involve ray tracing at a plurality of planes around the exit pupil position of the objective lens arrangement or physical determination using an optical jig to assess the cross section beam deformation at said plurality of planes. The Applicant has recognised that the effect of pupil wandering may cause some displacement in the position of an exit pupil for a light beam formed from reflected light at different field points. Deviations of the exit pupil position may be observed with respect to the optical axis for light beams originating from different field points. In order for the central opening or transmissive region of the light signal separation unit to be sufficiently wide to allow through substantially all reflected light from different field points on the object so as to reduce the amount of the central portion of the light beam being unintentionally received or blocked by the reflective surface of the light separation unit, embodiments of the present technology adjust the dimension of the central opening or transmissive region for such lateral displacement in exit pupil position. Compared to the conventional top-down approach, the present approach is capable of minimising or otherwise significantly reducing unnecessary “spares” or error margins in the dimension of the central opening or transmissive region, thus it is possible to improve the amount of light collected from the peripheral portion of the light received by the objective lens arrangement. The present approach is of particular relevance to systems with high numerical apertures (NA), in which the central portion of light is proportionately much larger than the peripheral portion; in other words, there is a much smaller peripheral portion that can be collected.

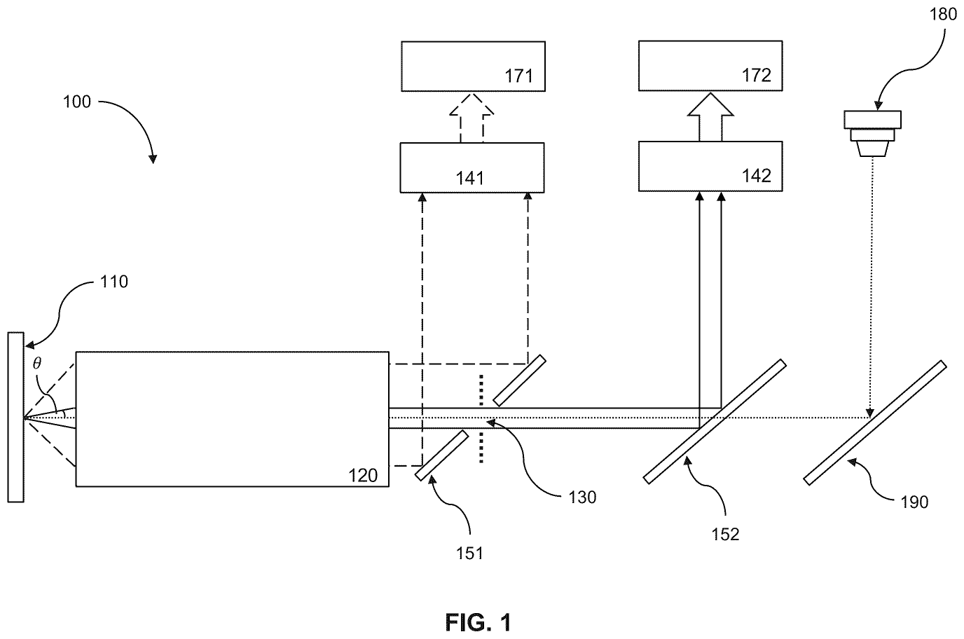

FIG. 1 shows schematically an exemplary inspection system 100 for inspecting a specimen according to an embodiment. For example, the inspection system 100 may be (but not limited to) a semiconductor wafer or mask inspection system for inspecting defects, particles and/or patterns on the surface of a semiconductor wafer as part of a quality assurance process in semiconductor manufacturing processes.

In the present embodiment, the inspection system 100 comprises a set of optical elements or, collectively, an optical system, which comprises, amongst other things, a plurality of lenses including an objective lens arrangement 120 and two imaging lenses or imaging lens arrangements 141, 142. In the present embodiment, the objective lens arrangement 120 is configured (e.g. aligned) such that an exit pupil 130 thereof is relayed to a position external (instead of internal) to the objective lens arrangement 120, for example (but not limited to) by providing a pupil relay module behind one or more of the objective arrangement lenses. Two light detectors apparatuses 171 and 172 are each respectively disposed behind the two imaging lenses or imaging lens arrangements 141, 142 for detecting an image formed by the imaging lenses or imaging lens arrangements 141, 142. The detectors arrays 171, 172 may for example comprise a camera or a photomultiplier array, or any other suitable optical detector. The inspection system 100 also comprises a platform 110 for receiving or securing an object or specimen for inspection. The platform 110 may be stationary or it may be a stage mechanism movable in a longitudinal direction (along the optical axis of the objective lens or objective lens arrangement 120, z-axis) and/or in a transverse direction (x-and/or y-axis) in the same plane as the platform 110. A light source or illumination source 180 is provided to the inspection system 100 for illuminating the object placed on the platform 110. For example, a stage mechanism may be configured to move in coordination with a scanning sequence to enable an object placed on the platform 110 to be scanned by the light source 180. The light source 180 may be a single point source (e.g. a laser) that illuminates a single point on the object or it may be an array of point sources that illuminates multiple points on the object simultaneously (thus capable of collecting information from multiple locations on the object simultaneously) or it may be an aerial illumination source which illuminates a continuous area.

A reflector 190 may be, and in the present embodiment is, placed along the optical axis of the objective lens arrangement 120 to direct a light beam or multiple light beams from the light source 180 (through the objective lens arrangement 120) towards the platform 110. This enables the light source 180 to be placed off the optical axis of the objective lens arrangement 120, for example to increase the compactness of the instrument. The illumination system comprised of the light source 180 and reflector 190 may form an afocal beam at an exit pupil thereof. The exit pupil of the illumination system may ideally be matched to the entrance pupil of the objective lens arrangement and with the back focal plane thereof.

Each set of imaging lens/imaging lens arrangement 141, 142 and its corresponding light detector apparatus 171, 172, according to the present embodiment, is arranged to detect a different portion of the light collected by the objective lens arrangement 120. In particular, for the present embodiment, the detector apparatus 171 is configured to detect darkfield (DF) signal that is light scattered by uneven features, such as defects and/or particles, on the surface of the object, while the detector apparatus 172 is configured to detect brightfield (BF) signal that is light reflected off the surface of the object, in which case uneven features of the surface of the object appear as dark features against a light background. Light reflected off a point on the object may be regarded as forming a cone originating from that point with a chief ray or a centroid ray perpendicular to the surface of the object being the central axis of the cone. Such a light cone can be characterized by a half angle θ defined with respect to the central axis. Then, any light that is outside of the cone, i.e. coming off a point on the object at an angle greater than θ with respect to the chief ray, may be regarded as scattered light which does not contain BF light or specular rays, hence can be detected with high SNR. Thus, in order to separate DF signal from BF signal, a light signal separator/divider 151 is provided, in the present embodiment, at or near (i.e. contiguous) the exit pupil 130 of the objective lens arrangement 120 (i.e. a theoretical position thereof). The light signal separator/divider 151 may for example be provided in the form of a mirror/reflector (e.g. a plane mirror) having formed therein an opening or transmissive region (e.g. an uncoated region of the mirror/reflector) substantially in the center. The light signal separator/divider 151 is arranged to allow therethrough the central portion of a light beam from the objective lens arrangement 120, which comprises light reflected off the surface of the object within the angle θ, while the peripheral portion of the light beam, which comprises light scattered off at an angle greater than θ, is collected and reflected in a different direction by the reflective surface.

In the present embodiment, the light signal separator/divider 151 is disposed at an angle (i.e. tilted) with respect to the optical axis of the objective lens arrangement 120, such that the peripheral portion of the light (DF signal) is directed off the illumination optical axis, enabling the imaging lens/imaging lens arrangement 141 and the detectors apparatus 171 to be arranged off the optical axis. Similarly, the imaging lens/imaging lens arrangement 142 and the corresponding detector apparatus 172 may also be, and in the present embodiment are, arranged off the optical axis of the objective lens arrangement 120 through the use of e.g. a partially reflective element 152 that is transmissive on one side to allow transmission of light from the light source 180 while reflective on the opposite side to reflect BF signal towards the BF detectors array 172. It should be understood that positioning the imaging lenses or imaging lens arrangements 141, 142 and the detector apparatuses 171, 172 and/or the light source 180 at an angle with respect to the optical axis of the objective lens or objective lens arrangement 120 is optional and not essential to the present technology.

The objective lens arrangement 120 is arranged to receive and collect light reflected from a plurality of field points on the object (e.g. light from the light source 180 reflected and/or scattered off a portion of the object, or transmitted through a portion of the object as in the case of a transmission microscope) and configured, in the present embodiment, for telecentric imaging at the object side. The objective lens arrangement 120 may, or elements of the objective lens arrangement 120 may be, arranged and aligned such that light collected from any given field point on the object by the objective lens arrangement 120 exits the objective lens arrangement 120, passing through an exit pupil 130 (illustrated as two dotted lines in FIG. 1), as parallel rays that is imaged at infinity. The light signal separator/divider 151 may be ideally disposed at the exit pupil 130 and arranged such that the central opening or transmissive region of the light signal separator/divider 151 coincides substantially with the exit pupil 130, laterally and axially. In other words, the system may be theoretically configured such that an entrance pupil of the objective lens arrangement matches the exit pupil of the objective lens arrangement and the back focal plane of the objective lens arrangement. However, because of errors in alignment and aberrations, the image of the entrance pupil (i.e. the exit pupil) of the objective lens arrangement may be slightly displaced from the entrance pupil of the objective lens arrangement and/or the back focal plane of the objective lens arrangement and/or the exit pupil of the illumination system. The light signal separator/divider 151 may therefore be positioned and dimensioned in accordance with the method described herein i.e. by determining an axial position at which the beam deformation is minimized and adjusting its opening/transmissive region dimensions in accordance with the beam deformation cross section at said axial position.

When designing a light signal separation unit, or coupling mirror, there are a number of considerations to take into account. For example, a light beam from the light source 180 needs to pass through the central opening or transmissive region of the light signal separation unit 151 before reaching the objective lens arrangement 120 to illuminate a specimen. Thus, for a given intensity of light, a central opening or transmissive region with a larger diameter would enable higher illumination uniformity of the specimen and better resolution. Illuminating the specimen with a wider angle of illumination can further improve resolution, and to achieve a wide illumination angle, a larger diameter of central opening or transmissive region is preferable. On the other hand, the larger the diameter of the central opening or transmissive region is, the higher proportion of light collected from the specimen is allowed through, and therefore less light is received and collected by the reflective surface of the light signal separation unit 151. Moreover, the wider the angle of illumination, the wider the angle of refraction is when light collected from the specimen exits the objective lens; in other words, a higher proportion of net scattered light (i.e. scattered light that does not contain BF rays) is lost and so a smaller proportion can be collected by the reflective surface of the light signal separation unit.

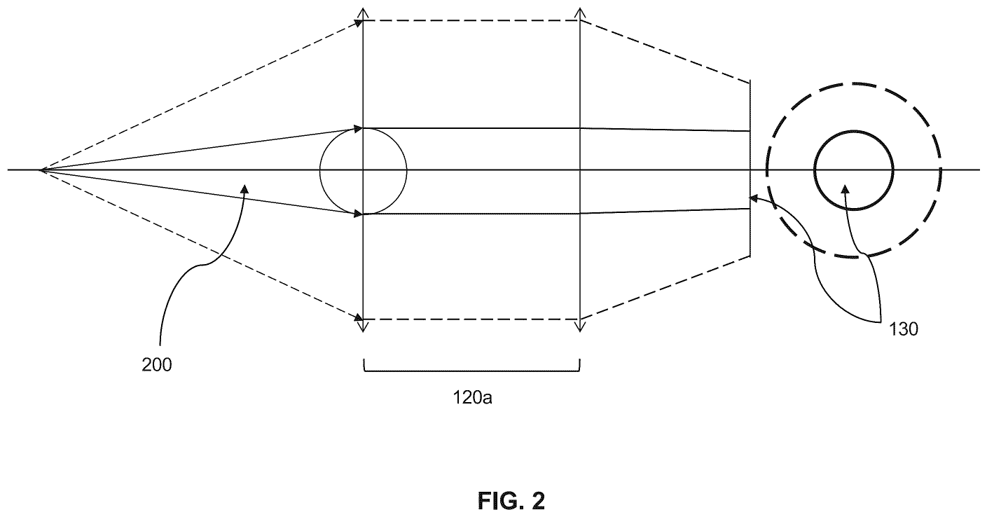

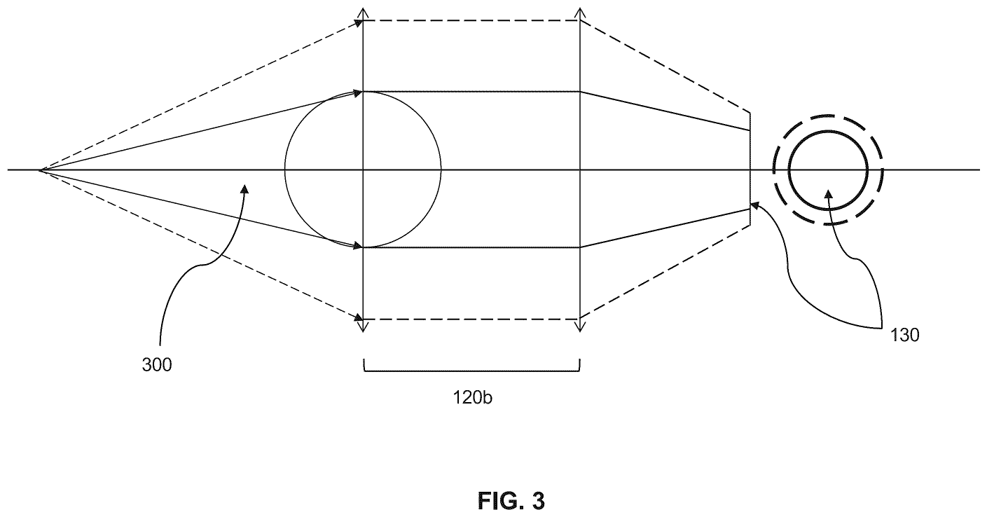

The issues arising from the central opening or transmissive region having a larger diameter cannot be straightforwardly compensated by providing a larger reflective area to the light signal separation unit, since the amount of DF signal that can be collected does not necessarily increase as the total diameter of the coupling mirror increases, as illustrated in FIGS. 2 and 3.

FIG. 2 schematically compares the size of BF signal with the size of DF signals in a low NA system. As can be seen, in the case of a low NA system, the angle within which light from a specimen can be collected by the objective lens arrangement 120a and passes through the exit pupil 130 is small (illustrated by the solid lines as a light cone 200). In this case, more peripheral light (DF signal), or scattered light outside of the light cone 200, can be collected by the objective lens arrangement 120a, which in turn can be collected by the reflective surface of a light signal separation unit.

On the other hand, FIG. 3 schematically compares the size of BF signal with the size of DF signals in a high NA system. As can be seen, in the case of a high NA system, the angle within which light from a specimen can be collected by the objective lens arrangement 120b and passes through the exit pupil 130 is larger compared to the system of FIG. 2 (illustrated by the solid lines as a light cone 300). In this case, less peripheral light (DF signal), or scattered light outside of the light cone 300, is available to be collected by the objective lens arrangement 120b, and as such less peripheral light can be collected by the reflective surface of a light signal separation unit.

As can be seen, the total amount of DF signal available for collection and detection is determined by the resolving power of the microscope system-the higher the resolution, the less DF signal there is available to collect. It is therefore particularly desirable to improve the efficiency of DF signal collection, for example through reducing or limiting signal loss by providing a light signal separation unit that does not have a wider-than-necessary central opening or transmissive region, when implementing a high NA microscope system.

There may be further contributing factors that can affect the amount of DF signal available and therefore the size of the central opening or transmissive region. For example, if the optics of the objective lens arrangement 120 are properly designed and set up with good alignment with minimal geometric aberration in pupil imaging, it may be possible that light received and collected by the objective lens arrangement 120 from every field point on a specimen would pass through the exit pupil 130 with minimal beam deformation and/or pupil wandering. However, in practice, a certain amount of alignment tolerances and geometric aberration is expected, such that beam deformation and lateral displacement of the exit pupil to varying extent are expected to be observed in a light beam exiting the objective lens arrangement 120 formed from light collected from different field points on the specimen. The extent of beam deformation and lateral displacement of the exit pupil, or pupil wandering, may be dependent on alignment tolerances of elements of the objective lens arrangement 120 as well as geometric imperfections of the lenses or optical instruments involved arising e.g. from the production process or the optical design of the objective lens arrangement. In view of this, it is therefore desirable to determine an axial position along the optical axis at which the effect of beam deformation and/or lateral displacement of a light beam exiting the objective lens arrangement is less or even substantially minimal.

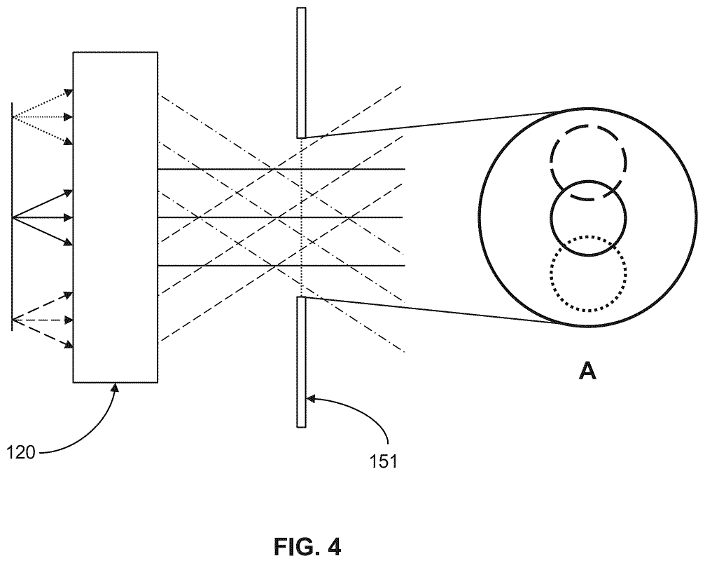

As can be seen in FIG. 4, alignment error and/or production imperfections resulting for example from variations in optical designs can cause beam deformation and some lateral displacement of the position of light beams formed from light reflected off different field points on the object surface (also known as pupil wandering). In FIG. 4, the effect of beam deformation and lateral displacement is exaggerated for the purpose of illustration only. In practice, such lateral deviations or variations may be in the range of a few percent. The effect of beam deformation and lateral displacement may be observed by placing e.g. a screen at different axial positions along the optical axis and observe the shape and position of an illuminated area formed thereon, or a detector apparatus may be used instead. As shown in FIG. 4, if a light signal separation unit 151 is placed at an axial position at which the effect of beam deformation and/or lateral displacement is large, in order to allow through the central portion of a light beam from different field points on the object, a large central transmissive region would be required.

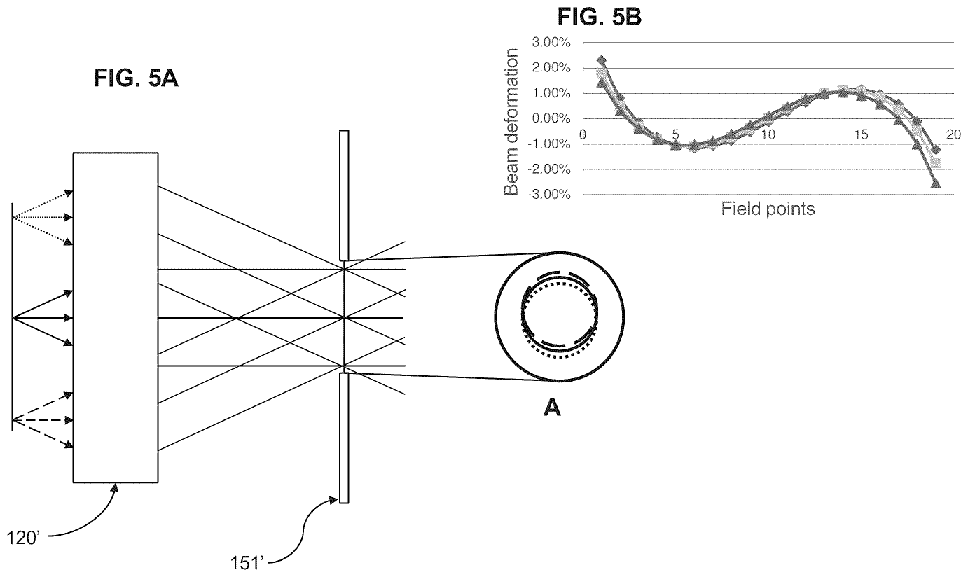

In order to enable the size of the central transmissive region of a light signal separation unit to be reduced, it is desirable to first determine an axial position at which the effect of beam deformation and/or lateral displacement is less or minimal, and dispose the light signal separation unit at this axial position. As illustrated in FIG. 5A, at the axial position at which the effect of beam deformation and/or lateral displacement is minimal, the dimension of the central transmissive region of the light separation unit 151′ can be reduced. Then, the dimension of the central transmissive region can be determined based on the cross-sectional area of the light beam at this axial position. The extent of beam deformation and lateral displacement may differ depending on the field point on the object from which a light beam is formed, as shown in FIG. 5B. As such, in some embodiments, it may be optional to determine, for each of a plurality of field points on the object, an axial position at which beam deformation is (substantially) minimal, then a final axial position may be selected based on the plurality of axial positions determined for the plurality of field points, for example a mean axial position. Optionally, a lateral displacement may be determined for a plurality of field points at the selected axial position, and the dimension of the central transmissive region may be adjusted e.g. by a maximum lateral displacement (an average lateral displacement may also be used if desired).

In some embodiments, it may be desirable to optimize the alignment of one or more optical elements of the optical system, in particular, elements of the objective lens arrangement 120, prior to determining the axial position of minimal beam deformation and lateral displacement and the size of the cross section of the light beam at the axial position. For example, for an objective lens arrangement that comprises a plurality of optical elements, such as (but not limited to) an objective lens and a telescope, an alignment of elements of the objective lens arrangement may be calibrated, for example using a calibration object, to optimize or otherwise improve the alignment of the objective lens arrangement. Thus, in some embodiments, the method may further comprise illuminating an object, e.g. a calibration object such as a mirror, through the objective lens arrangement to image an entrance pupil of the objective lens arrangement and an exit pupil formed by the illumination, and adjusting the alignment of one or more elements of the objective lens arrangement such that the entrance pupil substantially overlaps onto the exit pupil of the illumination. Moreover, the alignment of the objective lens arrangement may optionally be calibrated such that the entrance pupil and the exit pupil of the illumination are proximal to the back focal plane of the objective lens arrangement. When alignment is substantially optimized, beam deformation and lateral displacement can be reduced (see FIG. 5A showing a displacement in the order of a few percent), and in doing so, the area required to allow the BF signal to pass through can also be reduced.

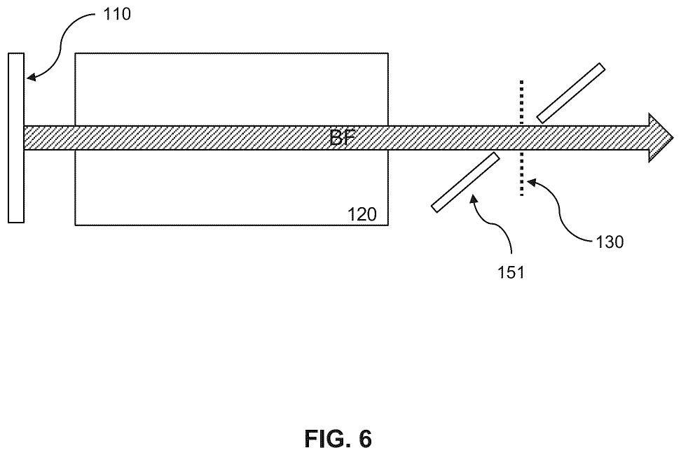

A further factor that may optionally be taken into account when determining the size of the central opening or transmissive region is when the plane of the central opening or transmissive region of the light signal separation unit does not coincide with the exit pupil plane (or the plane of the central opening or transmissive region is not perpendicular to the optical axis), as illustrated by FIG. 6. In other words, the plane of the central opening or transmissive region forms an angle with (or inclined or declined with respect to) the plane of the exit pupil of the objective lens arrangement. In this case, in order for the central opening or transmissive region to encompass all BF signal (all light within the angle θ in FIG. 1), as shown by the hashed arrow in FIG. 6, the central opening or transmissive region is preferably larger than the area of the exit pupil to adjust for such slanting effect.

In particular, the area of the central opening or transmissive region may be determined through analyses of computer simulations of the objective lens arrangement and the effect of differing an inclination angle on a cross-sectional area of the central portion of the light beam transmitted through the objective lens arrangement. For example, the central portion of light exiting the objective lens arrangement, or the central transmissive region of the light signal separation unit determined as describe above, may be simulated as a column, and the cross-sectional area of such a column as a function of angle may be analyzed.

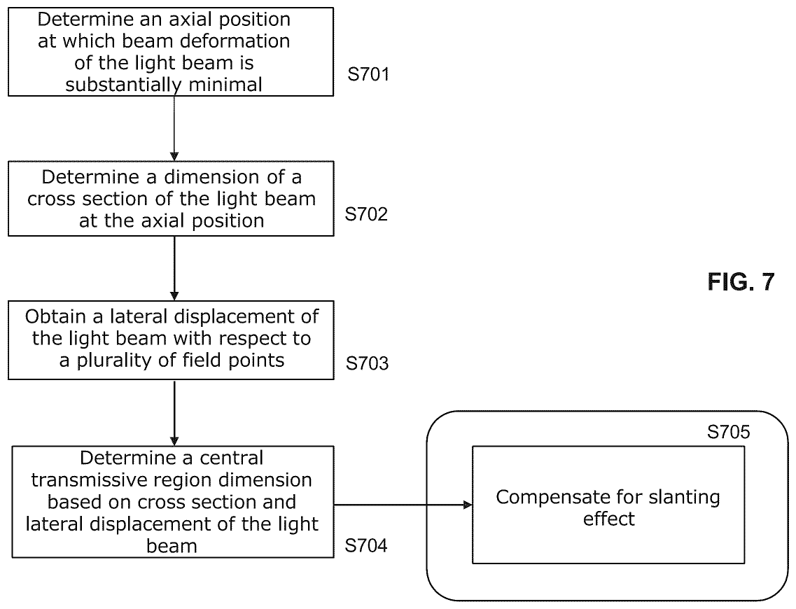

The present technology thus provides methods for providing or otherwise designing a light signal separator/divider. An embodiment is shown in FIG. 7, in which a method of providing a light signal separation unit in an optical microscope system according to present technology is shown. The optical microscope system may for example be the reflective optical microscope system 100 shown in FIG. 1, comprising an objective lens arrangement 120 configured to collect light reflected off a plurality of field points on an object and to onwardly transmit a light beam formed from the collected light and a light signal separation unit 151 having a reflective surface with a central opening or transmissive region formed therein. As described above, the central opening or transmissive region is arranged to allow therethrough a central portion (e.g. BF signal) of the light beam transmitted from the objective lens arrangement while the reflective surface is arranged to receive and reflect a peripheral portion (e.g. DF signal) of the light beam transmitted from the objective lens arrangement. The method begins at S701, at which an axial position is determined at which beam deformation of the light beam transmitted from the objective lens arrangement is substantially minimal, wherein the axial position is a position along the optical axis of the objective lens arrangement and proximal to an exit pupil of the objective lens arrangement. Then, at S702, a dimension of a cross section of the light beam is determined at the axial position. At S703, a lateral displacement of the light beam transmitted from the objective lens arrangement with respect to the plurality of field points is determined. The dimension of the central opening or transmissive region is determined at S704 based on the dimension of the cross section of the light beam at the axial position adjusted by the lateral displacement of the light beam at the axial position. Optionally, where appropriate, the determined dimension of the central opening or transmissive region may be adjusted, at S705, if the plane of the central opening or transmissive region is at an angle or slanted with respect to the plane of the exit pupil of the objective lens arrangement.

Embodiments of the present technology as described above may be implemented in the manufacturing of semiconductor inspection and metrology equipment; in particular, embodiments of the present techniques may be implemented in the manufacturing or treatment process for testing, measuring and/or calibrating an optical system to improve or optimize the design of a coupling mirror used in the optical system.

Embodiments of the present technology as described above for determining a dimension of a central transmissive region of a light signal separation unit, including the determination of an axial position at which beam deformation of a light beam existing the objective lens arrangement is substantially minimal, the determination of a lateral displacement of the light beam at the axial position, calibration of an alignment of elements of the objective lens arrangement, and/or the determination of an adjustment to the dimension of a central transmissive region based on an inclination angle may all or partially be done using computer simulations or experimentally, or a combination thereof. It will be understood that the methods described herein may be implemented as a set of machine-readable instructions executable by one or more processor, e.g. in a control module or a computer.

As will be appreciated by one skilled in the art, the present techniques may be embodied as a system, method or computer program product. Accordingly, the present techniques may take the form of an entirely hardware embodiment, an entirely software embodiment, or an embodiment combining software and hardware.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high-speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

The examples and conditional language recited herein are intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its scope as defined by the appended claims.

Furthermore, as an aid to understanding, the above description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to limit the scope or set forth the bounds of the present technology. These modifications are not an exhaustive list, and a person skilled in the art may make other modifications while nonetheless remaining within the scope of the present technology. In particular, the present technology could also be applied to a transmission microscope. Further, where no examples of modifications have been set forth, it should not be interpreted that no modifications are possible and/or that what is described is the sole manner of implementing that element of the present technology.

Moreover, all statements herein reciting principles, aspects, and implementations of the technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

It will be clear to one skilled in the art that many improvements and modifications can be made to the foregoing exemplary embodiments without departing from the scope of the present techniques.

1. A method comprising:
a. providing a wafer inspection tool including an optical reflective microscope system, said optical reflective microscope system being configured to provide a brightfield channel and a darkfield channel and comprising:
i. an illumination system providing ultraviolet illumination with wavelengths below 300 nm;
ii. an objective lens arrangement including an objective and a plurality of interchangeable telescopes coupled thereto to control a magnification and a numerical aperture of said optical reflective microscope, the objective lens arrangement being configured to collect light reflected off a plurality of field points on the wafer and to onwardly transmit a light beam formed from the collected light; and
iii. a light signal separation unit having a reflective surface with a central transmissive region formed therein, wherein said central transmissive region is arranged to allow therethrough a central portion of said light beam transmitted from said objective lens arrangement corresponding to the brightfield channel while said reflective surface is arranged to reflect a peripheral portion of said light beam transmitted from said objective lens arrangement corresponding to the darkfield channel;
b. determining an axial position at which to position said light signal separation unit, said axial position being a position along an optical axis of said objective lens arrangement, contiguous to an exit pupil of said objective lens arrangement, at which beam deformation of said light beam is substantially minimal;
c. determining a dimension of a cross section of said light beam at said axial position; and
d. determining a dimension of said central transmissive region based on said dimension of said cross section of said light beam at said axial position.

2. The method of claim 1, further comprising obtaining a lateral displacement of said light beam with respect to said plurality of field points on said object at said axial position and wherein determining a dimension of said central transmissive region is further based on said lateral displacement.

3. The method of claim 1, wherein said objective lens arrangement is configured such that said light beam formed from light collected from each field point of said plurality of field points on said object exiting said objective lens arrangement comprises parallel light rays to be imaged at infinity.

4. The method of claim 1, wherein determining a dimension of said cross section of said light beam comprises measuring a cross-sectional area or a diameter of said light beam at said axial position.

5. The method of claim 1, wherein said objective lens arrangement comprises a plurality of elements, the method further comprising reducing said beam deformation of said light beam by adjusting a relative position of said objective and plurality of telescopes of said objective lens arrangement.

6. The method of claim 1, wherein an entrance pupil of said objective lens arrangement and an exit pupil of said illumination system substantially overlap, wherein, preferably, said objective lens arrangement is configured such that said entrance pupil of the objective lens arrangement and said exit pupil of said illumination are contiguous to a back focal plane of said objective lens arrangement.

7. The method of claim 1, wherein said axial position substantially coincides with said exit pupil of said objective lens arrangement.

8. The method of claim 1, further comprising disposing said light signal separation unit at said axial position.

9. The method of claim 2, wherein obtaining a lateral displacement of said light beam with respect to said plurality of field points on said object at said axial position comprises obtaining a lateral displacement of said light beam for each of said plurality of field points by comparing, for each field point, a position of a light beam formed from light reflected off said field point with respect to said optical axis of said objective lens arrangement.

10. The method of claim 9, wherein determining a dimension of said central transmissive region comprises adjusting said dimension of said cross section of said light beam by a maximum lateral displacement.

11. The method of claim 1, wherein said wafer is being illuminated by an illumination source through said objective lens arrangement, and wherein determining an axial position at which to position said light signal separation unit comprises determining an axial position at which beam deformation of said light beam is substantially minimal for a plurality of axial and/or lateral exit pupil position of said illumination by varying a relative position of said illumination source and said objective lens arrangement.

12. The method claim 1, wherein determining a dimension of said cross section of said light beam comprises generating a computer simulation of said objective lens arrangement, using as inputs physical parameters of said objective lens arrangement and one or more tolerances with respect to said objective lens arrangement, and analysing a resulting simulation.

13. The method of claim 1, wherein said light signal separation unit is disposed such that a plane of said light signal separation unit is at an angle with respect to an exit pupil plane on which said exit pupil of said objective lens arrangement lies, the method further comprising adjusting said dimension of said central transmissive region based on said angle.

14. The method of claim 13, wherein adjusting said dimension of said central transmissive region based on said angle comprises simulating said dimension of said central transmissive region as a column and determining a cross-sectional area of said column at said angle.

15. A method comprising:
a. providing an optical reflective microscope system being configured to provide a brightfield channel and a darkfield channel and comprising:
i. an objective lens arrangement configured to collect light reflected off a plurality of field points on an object and to onwardly transmit a light beam formed from the collected light; and
ii. a light signal separation unit having a central region and a peripheral region configured for separating the brightfield channel and the darkfield channel;
b. determining an axial position at which to position said light signal separation unit, said axial position being a position along an optical axis of said objective lens arrangement, contiguous to an exit pupil of said objective lens arrangement, at which beam deformation of said light beam is substantially minimal;
c. determining a dimension of a cross section of said light beam at said axial position;
and
d. determining a dimension of said central region based on said dimension of said cross section of said light beam at said axial position.

16. A non-transitory computer-readable medium comprising machine-readable code which, when executed by a processor, causes the processor to
a. control a wafer inspection tool including an optical reflective microscope system, said optical reflective microscope system being configured to provide a brightfield channel and a darkfield channel and comprising:
i. an illumination system providing ultraviolet illumination with wavelengths below 300 nm;
ii. an objective lens arrangement including an objective and a plurality of interchangeable telescopes coupled thereto to control a magnification and a numerical aperture of said optical reflective microscope, the objective lens arrangement being configured to collect light reflected off a plurality of field points on the wafer and to onwardly transmit a light beam formed from the collected light; and
iii. a light signal separation unit having a reflective surface with a central transmissive region formed therein, wherein said central transmissive region is arranged to allow therethrough a central portion of said light beam transmitted from said objective lens arrangement corresponding to the brightfield channel while said reflective surface is arranged to reflect a peripheral portion of said light beam transmitted from said objective lens arrangement corresponding to the darkfield channel;
b. determine an axial position at which to position said light signal separation unit, said axial position being a position along an optical axis of said objective lens arrangement, contiguous to an exit pupil of said objective lens arrangement, at which beam deformation of said light beam is substantially minimal;
c. determine a dimension of a cross section of said light beam at said axial position;
and
d. determine a dimension of said central transmissive region based on said dimension of said cross section of said light beam at said axial position.

17. A wafer inspection tool including an optical reflective microscope system configured to provide a brightfield channel and a darkfield channel, said optical reflective microscope system comprising:
i. an illumination system providing ultraviolet illumination with wavelengths below 300 nm;
ii. an objective lens arrangement including an objective and a plurality of interchangeable telescopes coupled thereto to control a magnification and a numerical aperture of said optical reflective microscope, the objective lens arrangement being configured to collect light reflected off a plurality of field points on the wafer and to onwardly transmit a light beam formed from the collected light; and
a light signal separation unit comprising:
a reflective surface having a central transmissive region formed therein, wherein said central transmissive region is arranged to allow therethrough a central portion of said light beam transmitted from said objective lens arrangement corresponding to the brightfield channel while said reflective surface is arranged to reflect a peripheral portion of said light beam transmitted from said objective lens arrangement corresponding to the darkfield channel,
wherein a dimension of said central transmissive region of said light signal separation unit is determined by:
determining an axial position at which to position said light signal separation unit, said axial position being a position along an optical axis of said objective lens arrangement, proximal to an exit pupil of said objective lens arrangement, at which beam deformation of said light beam is substantially minimal;
determining a dimension of a cross section of said light beam at said axial position; and
determining a dimension of said central transmissive region based on said dimension of said cross section of said light beam at said axial position.

18. A wafer inspection tool according to claim 17 further comprising:
at least one imaging lens arrangement configured to receive light from said light signal separation unit to form an image; and
at least one light detector apparatus configured to detect said image formed by said at least one imaging lens arrangement.

19. The wafer inspection tool of claim 18, further comprising an illumination source arranged to illuminate said object through said objective lens arrangement by forming an afocal beam at an illumination exit pupil.

20. The wafer inspection tool of claim 19, wherein said at least one imaging lens arrangement comprises a first imaging lens arrangement configured to receive said peripheral portion of said light beam transmitted from said objective lens arrangement reflected by said reflective surface of said light signal separation unit to form a first image, and a second imaging lens arrangement configured to receive said central portion of said light beam transmitted from said objective lens arrangement through said central transmissive region of said light signal separation unit to form a second image.
